(19) United States
(12) Patent Application Publication
(10) Pub. No.: US 2012/0183078 A1
(43) Pub. Date: Jul. 19, 2012

(54) FILTER ADAPTATION WITH DIRECTIONAL FEATURES FOR VIDEO/IMAGE CODING

(75) Inventors: Wang Lin Lai, Richardson, TX (US); Felix Carlos Fernandes, Plano, TX (US)

(73) Assignee: Samsung Electronics Co., Ltd., Suwon-si (KR)

(21) Appl. No.: 13/347,589

(22) Filed: Jan. 10, 2012

Related U.S. Application Data
(60) Provisional application No. 61/432,951, filed on Jan. 14, 2011.
(60) Provisional application No. 61/449,490, filed on Mar. 4, 2011.
(60) Provisional application No. 61/450,404, filed on Mar. 8, 2011.
(60) Provisional application No. 61/534,267, filed on Sep. 13, 2011.

(51) Int. Cl. H04N 7/26

(52) U.S. Cl. 375/240.25; 375/240.29; 375/E07.027; 375/E07.193

(57) ABSTRACT

A method for processing video information by a video encoder includes classifying video information based on at least one local directional feature of the video information to design multiple filters. The encoder encodes filter coefficients of the multiple filters. The multiple filters are designed with symmetric constraints on the filter coefficients configured according to the classification of the video information based on at least one local directional feature of the video information. The method also includes applying, by the encoder, the multiple directional filters to the video information. A decoder is configured to decode filter coefficients of multiple filters and apply the multiple filters to the video information. The decoder constructs, from decoded filter coefficients, multiple filters with symmetric constraints on the filter coefficients configured according to the classification of the video information based on at least one local directional feature of the video information.

### CROSS-REFERENCE TO RELATED APPLICATION(S) AND CLAIM OF PRIORITY

The present application is related to U.S. Provisional Patent Application No. 61/432,951, filed Jan. 14, 2011, entitled “LOOP FILTER WITH DIRECTIONAL SIMILARITY MAPPING FOR IMAGE/VIDEO CODING”; U.S. Provisional Patent Application No. 61/449,490, filed Mar. 4, 2011, entitled “LOOP FILTER DESIGN WITH DIRECTIONAL SIMILARITY MAPPING FOR IMAGE/VIDEO CODING”; U.S. Provisional Patent Application No. 61/450,404, filed Mar. 8, 2011, entitled “LOOP FILTER DESIGN WITH DIRECTIONAL FILTERS FOR IMAGE/VIDEO CODING” and U.S. Provisional Patent Application No. 61/534,267, filed Sep. 13, 2011, entitled “FILTER ADAPTATION WITH DIRECTIONAL FEATURES FOR IMAGE/VIDEO CODING”. Provisional Patent Application No. 61/432,951, 61/449,490, 61/450,404 and 61/534,267 are assigned to the assignee of the present application and is hereby incorporated by reference into the present application as if fully set forth herein. The present application hereby claims priority under 35 U.S.C. §119(e) to U.S. Provisional Patent Application No. 61/432,951, 61/449,490, 61/450,404 and 61/534,267.

### TECHNICAL FIELD OF THE INVENTION

The present application relates generally to video image processing and, more specifically, to a system and method for video image encoding and decoding.

### BACKGROUND OF THE INVENTION

Hybrid video coding schemes, namely block-based motion compensation followed by transforms and quantization, results in coding artifacts due to its lossy nature. To further improve coding efficiency and the quality of encoded video, adaptive loop filtering (ALF) methods have been proposed, which design filters on a frame by frame basis to minimize the mean-squared error (MMSE filters). Frames after applying ALF will have improved visual quality, and serve as better references for temporal predictive coding to achieve higher coding efficiency. The estimated filter coefficients are encoded and transmitted as side information in the bitstream. Thus, the rate-distortion tradeoff in designing ALF schemes is between the size (rate) of side information and the quality improvement.

Various ALF approaches have been proposed to tackle different type of artifacts. For video content exhibiting localized focus changes, P. Lai, Y. Su, P. Yin, C. Gomila, and A. Ortega, “Adaptive filtering for video coding with focus change,” in Proc. IEEE International Conference on Acoustics, Speech, and Signal Processing (ICASSP) 2007, Honolulu, Hi., USA, pp. I.661-664, April 2007; designed multiple filters by classifying macroblocks (MB) based on the type of estimated local MB-wise focus changes. Then for each class of blocks, a Wiener filter is designed to compensate for the associated type of focus change. In inter-view disparity compensation for multiview video coding (MVC), since focus mismatch is depth-dependent and depth is the reciprocal of disparity, P. Lai, Y. Su, P. Yin, C. Gomila, and A. Ortega, “Adaptive filtering for cross-view prediction in multi-view video coding,” in Proc. SPIE Visual Communications and Image Processing (VCIP) 2007, San Jose, Calif., USA, January 2007; classified blocks in a video frame according to the block-wise disparity vectors. Again each class adapts to a MMSE Wiener filter. For more generic denoising purposes, T. Chujoh, A. Tanizawa, and T. Yamakage, “Block-based adaptive loop filter,” ITU-SG16 Q6 VCEG-AJ13, San Diego, Calif., USA, October 2008; T. Chujoh, N. Wada, T. Watanabe, G. Yasuda, and T. Yamakage, “Specification and experimental results of quadtree-based adaptive loop filter”, ITU-SG16 Q6 VCEG-AK22, Apr. 200; T. Watanabe, N. Wada, G. Yasuda, A. Tanizawa, T. Chujoh, and T. Yamakage, “In-loop filter using block-based filter control for video coding,” in Proc. IEEE International Conference on Image Processing (ICIP) 2009, Cairo, Egypt, pp. 1013-1016, Nov. 200; all designed a single Wiener filter per frame, while enabling spatial adaptation with filtering on/off control on equal-sized block basis as used in “Block-based adaptive loop filter” and “In-loop filter using block-based filter control for video coding”, or on hierarchical quadtree basis as used in “Specification and experimental results of quadtree-based adaptive loop filter”. M. Karczewicz, P. Chen, R. Joshi, X. Wang, W.-J. Chien, and R. Panchal, “Video coding technology proposal by Qualcomm Inc.” JCTVC-A121, Dresden, Germany, April 2010; further extended the single filter with quadtree-on/off control as in “Specification and experimental results of quadtree-based adaptive loop filter” to multiple filters with quadtree-on/off control, by classifying individual pixels (instead of classifying blocks) in a frame into 16 classes according to the magnitudes of sums of local Laplacian. To achieve the best coding efficiency, initially, a Wiener filter is designed for each pixel class. Then rate-distortions tests are conducted to possibly reduce the number of filters by merging different filter class-labels and redesign filters for the merged classes. Clearly, this procedure presents additional complexity in designing filters. Improved coding efficiency, as compared to single filter with quadtree-on/off control, has been reported. We will denote the adaptive filter design in “Video coding technology proposal by Qualcomm Inc.” it as QC_ALF. However, besides the aforementioned additional complexity associated with filter class-label merging and filter redesign, another drawback of QC_ALF is that since its classification only considers the magnitude of local Laplacian, the resulting linear Wiener filters tend to be low-pass and isotropic in general, and hence are not suitable for reducing artifacts around sharp edges.

To improve both coding efficiency and visual quality of video coding, this disclosure present an adaptive loop filtering design, which exploits local directional characteristics exhibit in the video content. Multiple simple directional features are computed and compared to classify blocks in a video. Each class of blocks adapt to a directional filter, with symmetric constraints imposed on the filter coefficients according to the dominant orientation determined by the classification. The design optionally combines linear spatial filtering and directional filtering with a similarity mapping function. To emphasis pixel similarity for explicit adaptation to edges, a simple hard-threshold mapping function can optionally be used to avoid artifacts arising from across-edge filtering.

### SUMMARY OF THE INVENTION

An apparatus includes a video/image encoder configured to design and apply multiple filters to video information. The multiple filters are designed according to classification of the video information based on at least one local directional feature of the video information. The video/image encoder is further configured to encode the filter coefficients of the multiple filters.

An apparatus includes a video/image encoder configured to design multiple filters with symmetric constraints on the filter coefficients configured according to the classification of the video information based on at least one local directional feature of the video information.

An apparatus includes a video/image decoder configured to decode filter coefficients of multiple filters and apply the multiple filters to the video information. The multiple filters are applied according to classification of the video information based on at least one local directional feature of the video information.

An apparatus includes a video/image decoder configured to construct, from decoded filter coefficients, multiple filters with symmetric constraints on the filter coefficients configured according to the classification of the video information based on at least one local directional feature of the video information.

A method includes classifying video information based on at least one local directional feature of the video information to design multiple filters. The method also includes encoding filter coefficients of the multiple filters. The method further includes applying multiple filters to the video information.

A method includes designing multiple filters with symmetric constraints on the filter coefficients configured according to the classification of the video information based on at least one local directional feature of the video information.

A method includes decoding filter coefficients of multiple filters. The method also includes applying the multiple filters to video information. Applying the multiple filters includes classifying the video information based on at least one local directional feature of the video information.

A method includes constructing, from decoded filter coefficients, multiple filters with symmetric constraints on the filter coefficients configured according to the classification of the video information based on at least one local directional feature of the video information.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 provides a high-level block diagram of a video encoder with ALF;

FIG. 2 provides a high-level block diagram of a video decoder with ALF;

FIG. 3 illustrates flowchart of directional ALF at encoder, according to embodiments of the present disclosure;

FIG. 4 illustrates flowchart of directional ALF at decoder, according to embodiments of the present disclosure;

FIG. 5 illustrates directional classifications according to embodiments of the present disclosure;

FIG. 6 illustrates pixels locations for computing directional features according to embodiments of the present disclosure;

FIGS. 7 through 10 illustrate filter coefficients for directional classes according to embodiments of the present disclosure; and

FIG. 11 illustrates a Scanning order for coefficient differences according to embodiments of the present disclosure.

### DETAILED DESCRIPTION OF THE INVENTION

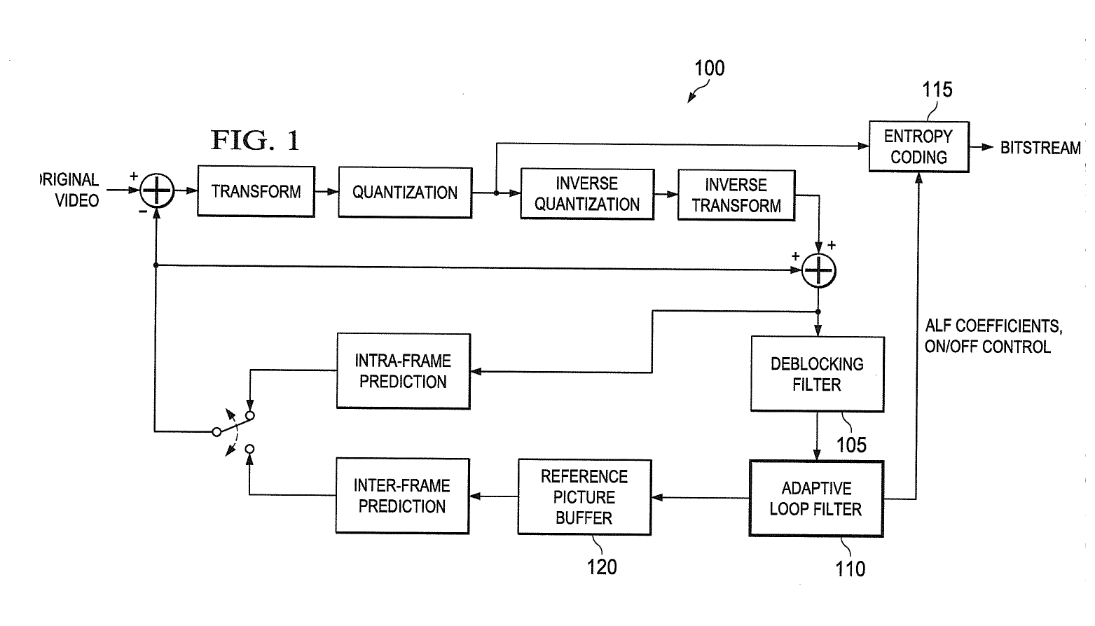

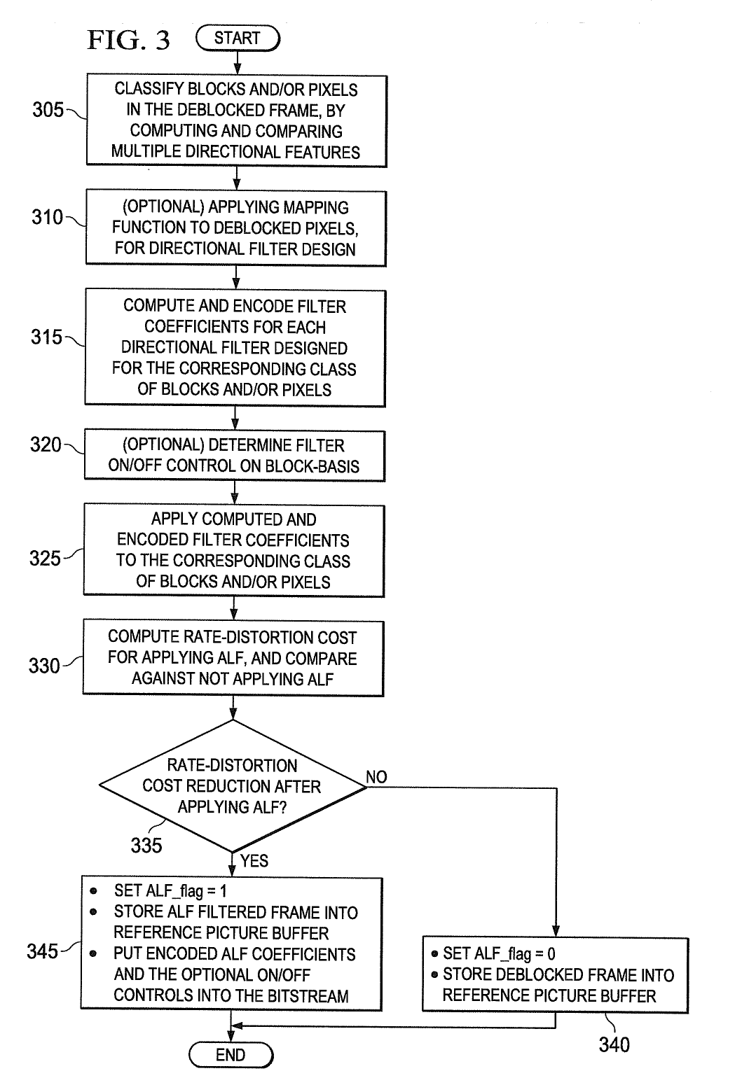

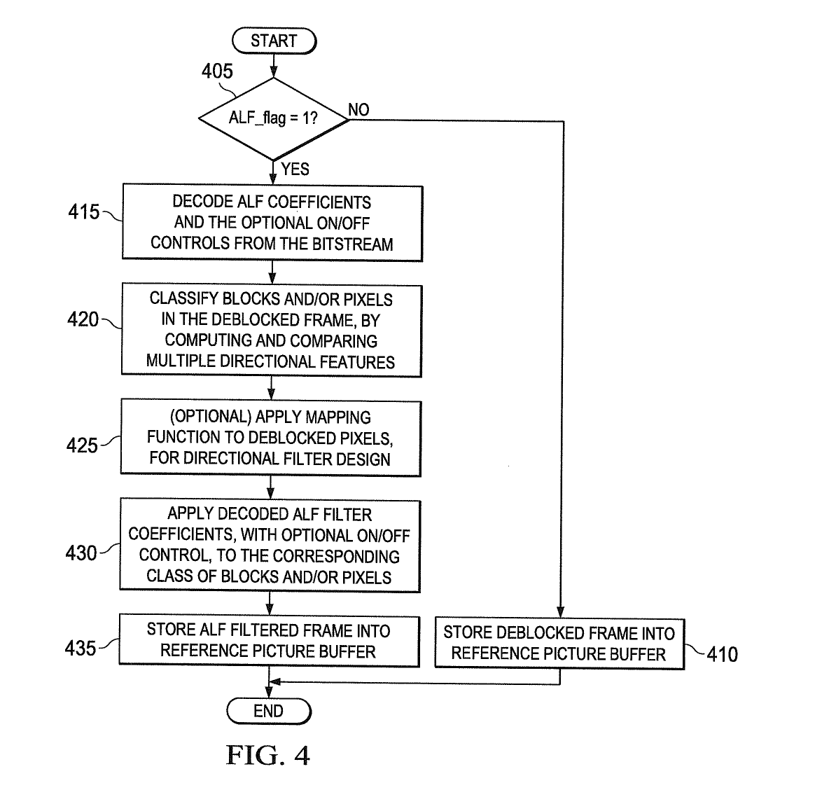

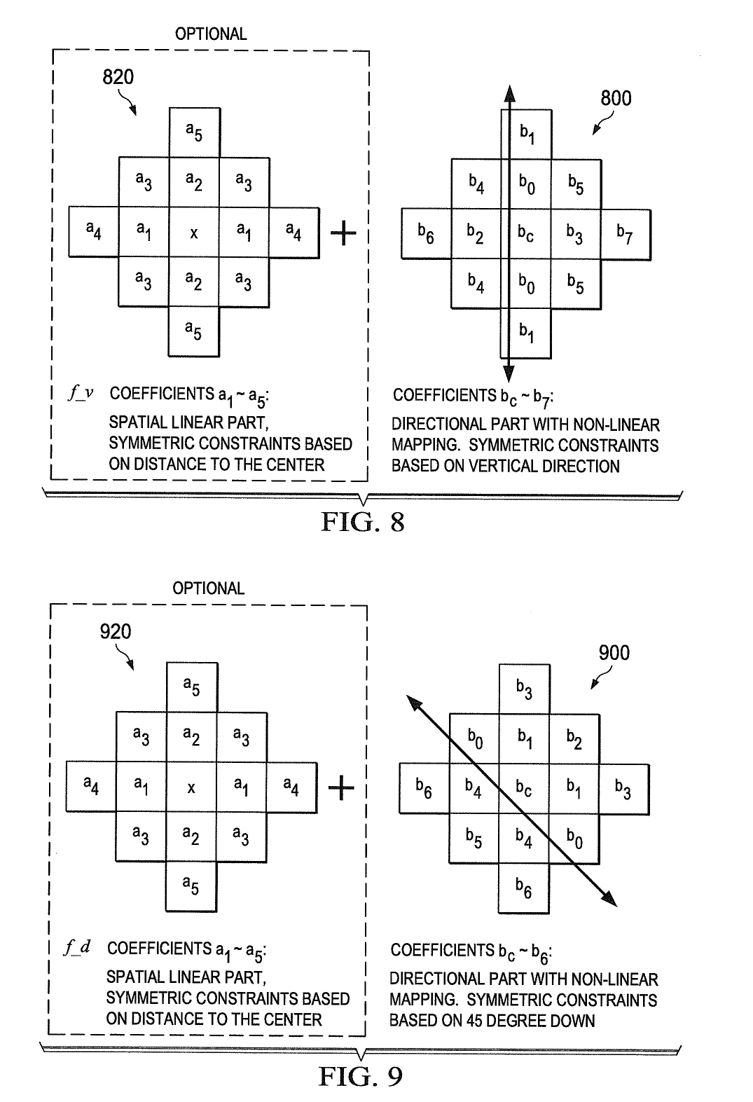

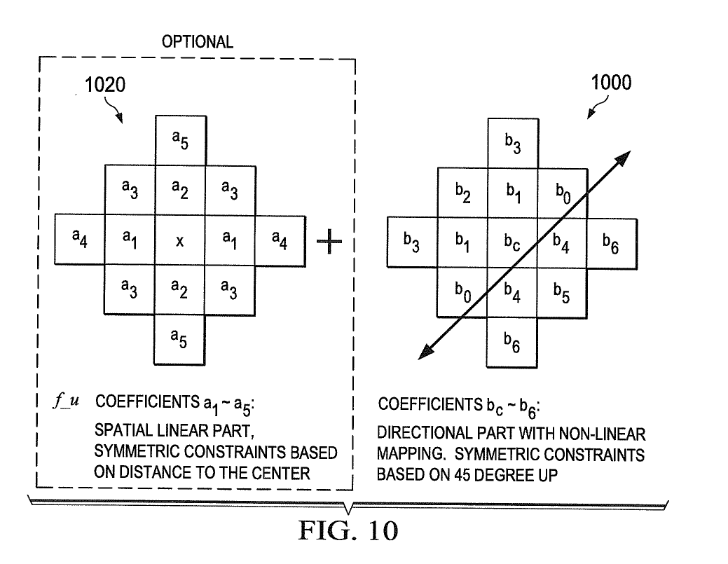

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged image processing system.

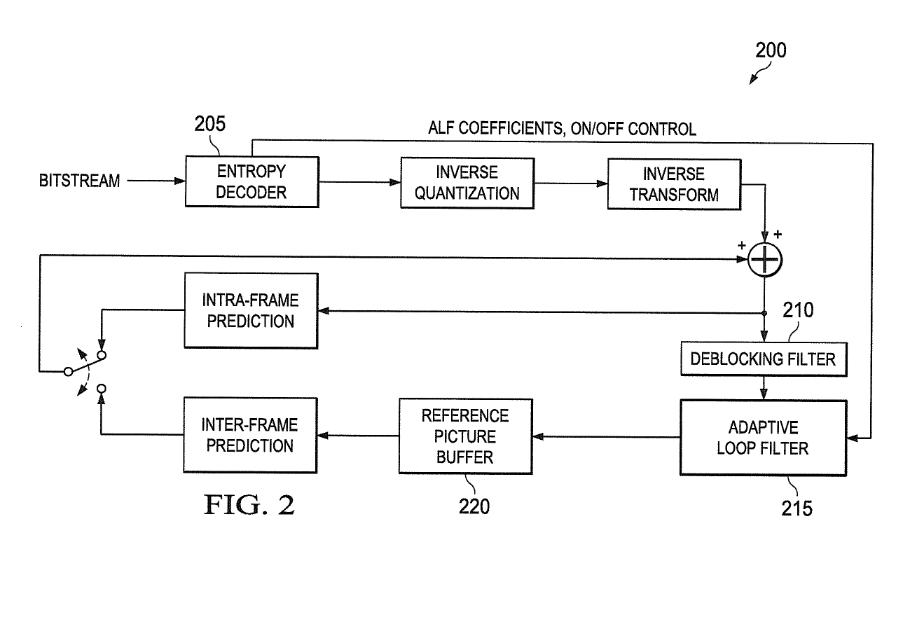

FIG. 1 illustrates an encoder with ALF according to embodiments of the present disclosure. FIG. 2 illustrates a decoder with ALF according to embodiments of the present disclosure. The embodiment of the encoder 100 shown in FIG. 1 and the video decoder 200 shown in FIG. 2 are for illustration only. Other embodiments could be used without departing from the scope of this disclosure.

The encoder 100 includes a de-blocking filter 105 and an Adaptive Loop Filter (ALF) 110. The ALF 110 designs and apply ALF after the de-blocking filter 105 and is configured to receive an output from the de-blocking filter 105 and provide an outputted signal to an entropy coding block 115 and a reference picture buffer 120. The filtered references are stored in the reference picture buffer 120. Filter coefficients and a control map need to be encoded into the bitstream.

Embodiments of the present disclosure provide a modified adaptive loop filter 110 that includes a Loop filter designed with directional features. There are two main ALF functionality provided in this disclosure: 1. Classifying pixels or blocks in a video frame by computing and comparing at least one directional features, for filter adaptation; and 2. Constructing directional filters wherein symmetric constraints are imposed on the filter coefficients according to the directional classification.

The video decoder 200 includes an entropy decoder 205, which decode the ALF filter coefficients and on/off control map; and a de-blocking filter 210 and an Adaptive Loop Filter (ALF) 215, which construct filter(s) according to the decoded filter coefficients, received as the output from the entropy decoder 205, and apply the filter(s) after the de-blocking filter 210. The ALF 215 provides an outputted signal to a reference picture buffer 220. The filtered references are stored in the reference picture buffer 220. Embodiments of the present disclosure provide a modified adaptive loop filter 215 that includes a Loop filter designed with directional features.

Similar to the ALF 110 in the encoder 100, embodiments of the present disclosure provide the ALF 215 in the video decoder with two main ALF functionality: 1. Classifying pixels or blocks in a video frame by computing and comparing at least one directional features, for filter adaptation; and 2. Constructing directional filters wherein symmetric constraints are imposed on the filter coefficients according to the directional classification.

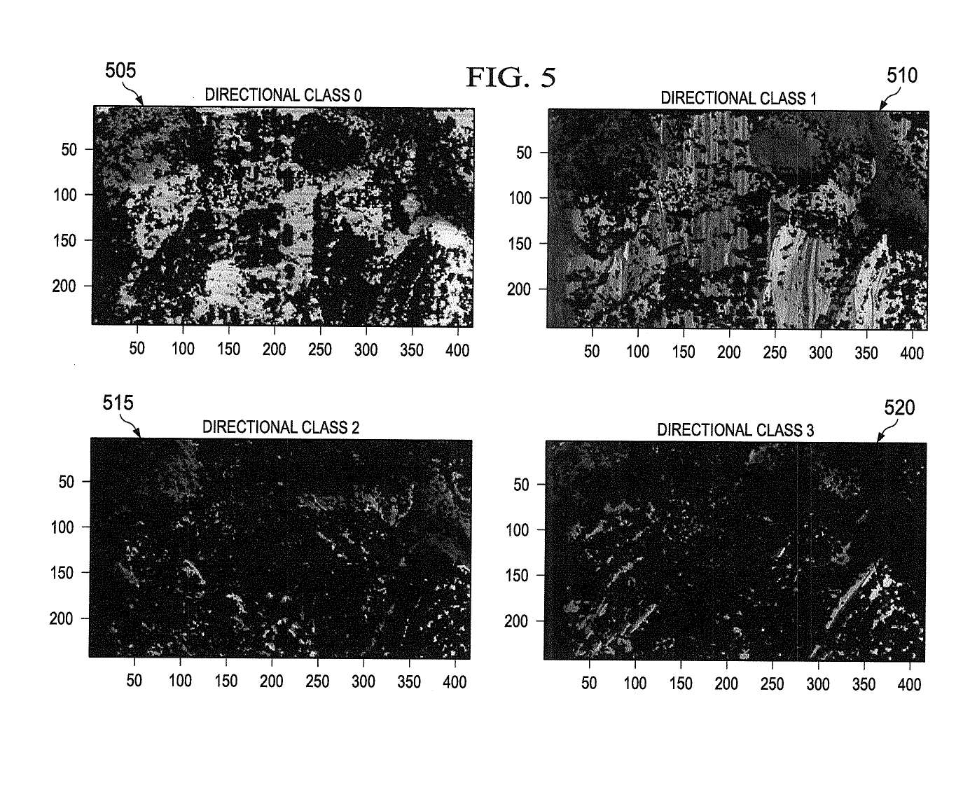

First, the classification by computing and comparing at least one directional features is explained. FIG. 5 illustrates directional classifications according to embodiments of the present disclosure. The embodiments of the directional classifications shown in FIG. 5 are for illustration only and other embodiments could be used without departing from the scope of this disclosure.

In certain embodiments, pixel classification is based on directional features, such as local gradients. That is, the reconstructed pixels in a video frame are classified into four classes based on the direction of local gradients.

For each pixel X(i,j), the four directional local gradients are computed as follows:

$$\begin{matrix}grad\_h ( i , j ) = {\sum }_{k = - L}^{L} {\sum }_{l = - L}^{L} \vert \begin{matrix}2 X ( i + k , j + l ) - \\ X ( i + k , j + l + 1 ) - X ( i + k , j + l - 1 )\end{matrix} \vert & [ Eqn . 1 ] \\ grad\_v ( i , j ) = {\sum }_{k = - L}^{L} {\sum }_{l = - L}^{L} \vert \begin{matrix}2 X ( i + k , j + l ) - \\ X ( i + k + 1 , j + l ) - X ( i + k - 1 , j + l )\end{matrix} \vert & [ Eqn . 2 ] \\ grad\_d ( i , j ) = {\sum }_{k = - L}^{L} {\sum }_{l = - L}^{L} \vert \begin{matrix}2 X ( i + k , j + l ) - \\ X ( i + k + 1 , j + l + 1 ) - X ( i + k - 1 , j + l - 1 )\end{matrix} \vert & [ Eqn . 3 ] \\ grad\_u ( i , j ) = {\sum }_{k = - L}^{L} {\sum }_{l = - L}^{L} \vert \begin{matrix}2 X ( i + k , j + l ) - X ( i + k - 1 , j + l + 1 ) - \\ X ( i + k + 1 , j + l - 1 )\end{matrix} \vert & [ Eqn . 4 ]\end{matrix}$$

Therefore, within the neighborhood of ±L pixels, grad_h measures the horizontal gradient, grad_v measures the vertical gradient, grad_d measures the gradient of 45 degrees (°) down, and grad_u measures the gradient of 45° up. Then, the pixel X(i,j) will be assigned as directional class D(i,j) according to the direction with minimum local gradient: min_g(i,j)=min{grad_h(i,j), grad_v (i,j), grad_d(i,j), grad_u (i,j)}:

D(i,j)=0if min_{—}g(i,j)=grad_{—}h(i,j) [Eqn. 5]

D(i,j)=1if min_{—}g(i,j)=grad_{—}v(i,j) [Eqn. 6]

D(i,j)=2if min_{—}g(i,j)=grad_{—}d(i,j) [Eqn. 7]

D(i,j)=3if min_{—}g(i,j)=grad_{—}u(i,j) [Eqn. 8]

Using Equations 5 through 8, the ALF 110 classifies pixels into classes with similar edge and feature directions in step 305. The ALF 110 classifies blocks and/or pixels in the deblocked frame by computing and comparing multiple directional features. In certain embodiments, the ALF 110 applies, in block 310, a mapping function to deblocked pixels for a directional filter design. In block 315, the ALF 110 computes and encodes filter coefficients for each directional filter designed for the corresponding class of blocks and/or pixels. In certain embodiments, the ALF 110 determines filter on/off control on a block-basis in block 320. In block 325, the ALF 110 applies the computed and encoded filter coefficients to the corresponding class of blocks and/or pixels. Thereafter, in block 330, the ALF 110 computes rate-distortion cost for applying adaptive loop filtering and compares, in block 335, the computed rate-distortion cost against not applying adaptive loop filtering. If there is no rate-distortion cost reduction after applying ALF, the ALF 110 sets a flag to zero (0) and stores the deblocked frame into reference picture buffer in block 340. If there is a rate-distortion cost reduction after applying ALF, the ALF 110 sets a flag to one (1) and stores the filtered frame into reference picture buffer 120 and puts encoded ALF coefficients and the optional on/off controls into the bitstream in block 345. In some embodiments, the ALF 110 does not perform one or more of blocks 310 and 320. That is, in certain embodiments, on or more of blocks 310 and 320 are optional.

To decode the video frame, the ALF 215 determines, in block 405, whether the flag is set to zero (0) or one (1). If the flag is set to zero (0), the ALF 215 stores the deblocked frame into the reference picture buffer 220 in block 410. Alternatively, if the flag is set to one (1), the ALF 215 decodes the ALF coefficients and the optional on/off controls from the bitstream in block 415. Thereafter, in block 420, the ALF 215 classifies blocks and/or pixels in the deblocked frame by computing and comparing multiple directional features. In certain embodiments, the ALF 215 applies a mapping function to the deblocked pixels for directional filter design. In block 430, the ALF 215 applies decoded ALF filter coefficients, with optional on/off controls, to the corresponding class of blocks and/or pixels. Thereafter, the ALF 215 stores the ALF filtered frame into reference picture buffer 220 in block 435. In some embodiments, the ALF 215 does not perform block 425. That is, in certain embodiments, block 425 is optional.

The examples shown in FIG. 5 show the classified results of a frame in the HEVC test sequence BlowingBubble. It can be seems that pixels in Class-0 505 and Class-1 510 have dominant edges and features in horizontal and vertical directions respectively. Similarly, pixels in Class-2 515 and Class-3 520 have dominant edges and features in the two corresponding diagonal directions. For each class, a directional filter with similarity mapping will be designed.

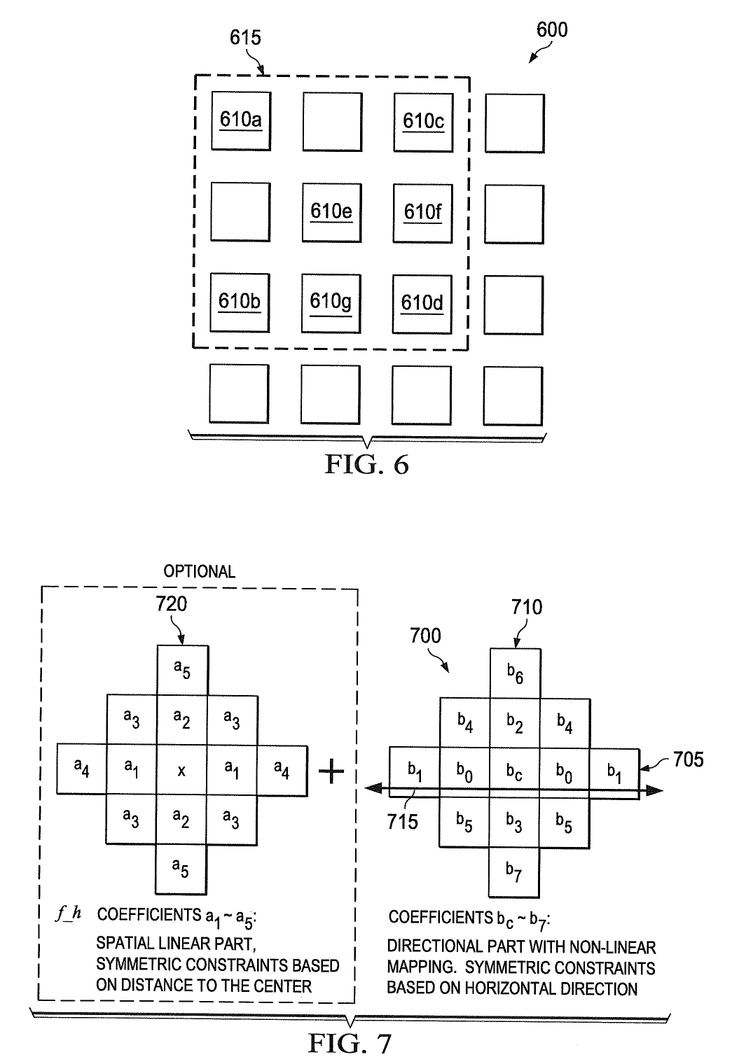

In certain embodiments, the ALF 410 is configured to employ a block-based filter adaptation based on direction of local gradients. The reconstructed blocks in a video frame are classified into four classes based on the direction of local gradients. For example, a 4-by-4 block 600 to be classified is shown in FIG. 6. FIG. 6 illustrates various subsets of pixels locations within the 4-by-4 block 600 for computing directional features according to embodiments of the present disclosure. The embodiment of the directional classification of block of 4-by-4 pixels 600 is for illustration only. Other embodiments could be used without departing from the scope of this disclosure. The directional class is one of Directional class-0 505, Directional class-1 510, Directional class-2 515 and Directional class-3 520.

In general, for a N-by-N block B(i,j) with the top-left pixel X(Ni,Nj), the four directional local gradients can be computed using [−1, 2, −1] weights as follows:

$$\begin{matrix}grad\_h ( i , j ) = {\sum }_{k = - L}^{L} {\sum }_{l = - L}^{L} \vert \begin{matrix}2 X ( Ni + k , Nj + l ) - \\ X ( Ni + k , Nj + l + 1 ) - X ( Ni + k , Nj + l - 1 )\end{matrix} \vert & [ Eqn . 9 ] \\ grad\_v ( i , j ) = {\sum }_{k = - L}^{L} {\sum }_{l = - L}^{L} \vert \begin{matrix}2 X ( Ni + k , Nj + l ) - \\ X ( Ni + k + 1 , Nj + l ) - X ( Ni + k - 1 , Nj + l )\end{matrix} \vert & [ Eqn . 10 ] \\ grad\_d ( i , j ) = {\sum }_{k = - L}^{L} {\sum }_{l = - L}^{L} \vert \begin{matrix}2 X ( Ni + k , Nj + l ) - \\ \begin{matrix}X ( Ni + k + 1 , Nj + l + 1 ) - \\ X ( Ni + k - 1 , Nj + l - 1 )\end{matrix}\end{matrix} \vert & [ Eqn . 11 ] \\ grad\_u ( i , j ) = {\sum }_{k = - L}^{L} {\sum }_{l = - L}^{L} \vert \begin{matrix}2 X ( Ni + k , Nj + l ) - \\ \begin{matrix}X ( Ni + k - 1 , Nj + l + 1 ) - \\ X ( Ni + k + 1 , Nj + l - 1 )\end{matrix}\end{matrix} \vert & [ Eqn . 12 ]\end{matrix}$$

Alternatively, the four directional local gradients can be computed using [1, −1] weights as follows. It should be noted that similar [−1, 1] weights can be used and the corresponding equations are straightforward. Also note that the two-weight gradient computation can also be applied to pixel-based filter adaptation to modify Equation 1 through Equation 4.

$$\begin{matrix}grad\_h ( i , j ) = {\sum }_{k = - L}^{L} {\sum }_{l = - L}^{L} \vert X ( Ni + k , Nj + l ) - X ( Ni + k , Nj + l + 1 ) \vert & [ Eqn . 13 ] \\ grad\_v ( i , j ) = {\sum }_{k = - L}^{L} {\sum }_{l = - L}^{L} \vert X ( Ni + k , Nj + l ) - X ( Ni + k + 1 , Nj + l ) \vert & [ Eqn . 14 ] \\ grad\_d ( i , j ) = {\sum }_{k = - L}^{L} {\sum }_{l = - L}^{L} \vert X ( Ni + k , Nj + l ) - X ( Ni + k + 1 , Nj + l + 1 ) \vert & [ Eqn . 15 ] \\ grad\_u ( i , j ) = {\sum }_{k = - L}^{L} {\sum }_{l = - L}^{L} \vert X ( Ni + k , Nj + l ) - X ( Ni + k - 1 , Nk + l + 1 ) \vert & [ Eqn . 16 ]\end{matrix}$$

Therefore, if L=1, the top-left 9 pixels illustrated by the 3-by-3 dash-line rectangle within the 4-by-4 block 600 will be used to compute directional features: grad_h measures the horizontal gradient, grad_v measures the vertical gradient, grad_d measures the gradient of 45 degree down, and grad_u measures the gradient of 45 degree up. Then all the pixel in block B(i,j) will be assigned as directional class D(i,j) according to the direction with minimum local gradient: min_g(i,j)=min{grad_h(i,j), grad_v (i,j), grad_d(i,j), grad_u (i,j)} according to Equations 5 through 8. Similarly, other embodiments can be constructed such as using the top-left 4 pixels within the current 4-by-4 block to be classified.

This will classify blocks into classes with similar edge and feature directions (block-based filter adaptation). Such filter adaptation will have lower complexity as compared to pixel-based filter adaptation where the gradients are computed for every pixel.

The utilization of [1, −1] weights in gradient computation also reduce complexity as compared to using [−1, 2, −1] weight. Note that for each N-by-N block B(i,j), pixels other than the top-left pixel X(Ni,Nj) can also be used to compute directional gradient to classify all pixels in into the same directional class. Using the top-left pixel X(Ni,Nj) is just an example.

In certain embodiments, a subset of pixels in the N-by-N block can be used. For example, four of the pixels 610a through 610d from the 4-by-4 block 600 may be selected, which corresponds to a uniform sub-sampling. The directional computations are then performed on the selected pixels 610a through 610d.

Computing directional features using pixel from the top-left corner could require accessing pixels outside the current 4-by-4 block 600 to be classified. For example to compute directional features at pixel 610a, pixels on top of 610a or to the left of 610a also need to be accessed, if the features are computed based on Equation 9-12. Thus, in certain embodiments, the ALF selects pixels 605d through 605g to ensure that the calculations access only pixels from within the 4-by-4 block 600 for the directional classification.

Beside classification by computing and comparing at least one directional features, a second functionality this disclosure provides is constructing directional filters wherein symmetric constraints are imposed on the filter coefficients according to the directional classification. FIGS. 7 through 10 illustrate filter coefficients for directional classes according to embodiments of the present disclosure. The embodiments of the filter coefficients shown in FIGS. 7 through 10 are for illustration only. Other embodiments could be used without departing from the scope of this disclosure. In FIGS. 7 through 10, the dashed-line box indicates an optional process such that the spatial linear portion can be optionally performed while the directional (right) portion can be performed alone. The embodiments with shapes in FIGS. 7 through 10 are for illustration only. Other embodiments (such as larger/smaller diamond shapes, square-shapes, etc.) could be used without departing from the scope of this disclosure.

In certain embodiments, in order to consider the proximity between pixels as well as the directional pixel value similarity, the ALF 410 filters contain a spatial linear part (with M coefficients aₘ) and another directional part (with N coefficients bₙ) with optional simple non-linear mapping. For a pixel Xₚ to be filtered, a diamond shaped 5×5 window centered at Xₚ and containing thirteen pixels will be used to produce the filtered results Yₚ:

$${Y}_{p} = {\sum }_{m = 0}^{M - 1} {a}_{m} \cdot {X}_{m} + {\sum }_{n = 0}^{N - 1} {b}_{n} \cdot {X}_{n}^{′} \qquad [ Eqn . 17 ]$$

where Xₘ are the neighboring pixels, and X′ₙ are optionally modified neighboring pixels after applying the mapping function described later in this disclosure.

The coefficients aₘ and bₙ can be obtained by solving MMSE equations for pixels in each directional class D_k:

$$min \{ {a}_{m} , {b}_{n} \} {\sum }_{p ∈ D \_ k} {( {I}_{p} - ( {\sum }_{m = 0}^{M - 1} {a}_{m} \cdot {X}_{m} + {\sum }_{n = 0}^{N - 1} {b}_{n} \cdot {X}_{n}^{′} ) )}^{2} \qquad [ Eqn . 18 ]$$

where Iₚ are the original pixel before encoding.

As shown in Equation (17) and (18), the filters restore the reconstructed frames toward the original frame by applying coefficients aₘ and bₙ to the neighboring pixels, subject to the optional similarity mapping.

FIGS. 7 through 10 illustrate the symmetric constraints of the four filters f_h 700, f_v 800, f_d 900, and f_u 1000, corresponding to pixels in each of the directional class respectively as in the example FIG. 5. The directional filter coefficients bₙ exploit the characteristics of dominant edge/feature directions for pixels in each class. For example, the directional filter in f_h 700, the same coefficient is assigned only to pixels 705 on the same horizontal line 715, while pixels 710 on the same vertical line are all assigned to different coefficients. There are thirteen pixel locations within the directional filter support (include the center), while nine coefficients bₙ (b_{c}˜b₇) are transmitted for f_h 700. As for the spatial linear part 720 with coefficients aₘ, the symmetric constraints are the same for all four filters: five coefficients aₖ (exclude the center) are transmitted for the support of the thirteen pixels.

In certain embodiments, only the directional filter (coefficients bₙ) is utilized, with optional simple non-linear mapping. That is, the spatial components 720, 820, 920, 1020, shown enclosed by dashed-box, are optional and are not included.

For example, using 5×5 filters, the four filters f_h, f_v, f_d, and f_u, include directional filter coefficients bₙ to exploit the characteristics of dominant edge/feature directions for pixels in each class. For example the directional filter in f_h 700, same coefficient is assigned only to pixels 705 on the same horizontal line 715, while pixels 710 on the same vertical line are all assigned to different coefficients. Similarly, 7×7 filters are constructed by only taking the directional parts with coefficients bₖ in with the center pixel (coefficients b_{c}). Other filter shapes (such as larger/smaller diamond shapes, square-shapes, etc.), with or without the optional linear spatial part, could be used without departing from the scope of this disclosure which utilizes symmetric constraints on filter coefficients according to the directional classification.

In certain embodiments, a simple non-linear mapping for pixels is utilized in the directional filter. This non-linear mapping is configured to avoid using neighboring pixels Xₙ with large value differences from the pixel Xₚ to be filtered. A similar principle is used in the bilateral filtering discussed in C. Tomasi and R. Manduchi, “Bilateral Filtering for Gray and Color Images”, in Proc. IEEE International Conference on Computer Vision, Bombay, India 1998, the contents of which are incorporated by reference. In Bilateral Filtering for Gray and Color Images, smaller filter weights are assigned to pixels Xₙ with large value differences from the pixel Xₚ. However Tomasi and Manduchi bilateral filter is not a MMSE Wiener filter: The filter weights are determined based on kernels such as Gaussian functions, instead of being calculated to minimize prediction error. Thus it does not guarantee to improve PSNR measurement and consequently is typically not used as loop filter for video coding. The embodiments of directional similarity filter with mapping in the present disclosure maintain this edge-preserving capability, while can also use MMSE computation to obtain coefficients as in Equation 18.

In embodiments of the present disclosure, the non-linear mapping function is a simple hard-thresholding as the following:

For Xₚ to be filtered, map its neighboring pixels Xₙ to Xₙ′:

X_{N}′=X_{N} if |X_{N}−X_{P}|≦σ/2 [Eqn. 19]

X_{N}′=X_{N} if |X_{N}−X_{P}|>σ/2 [Eqn. 20]

That is, for a neighboring pixel Xₙ with |X_{N}−X_{P}|≦σ/2, the value for Xₙ will not be changed. However if |X_{N}−X_{P}|>σ/2, it is determined that this pixel value should not be considered in the directional similarity filter. The value of σ should take into account the degree of coding error, which is typically controlled by the quantization parameter QP: Larger QP values lead to higher degree of coding error, such that the reconstructed values could deviate farther away from their original values, while still not to the extent of having the values like pixels on the other side of an edge. Thus the filter design should be more aggressive under high QP scenario in order to suppress stronger coding artifacts, indicating the use of larger threshold σ. In certain embodiments, the threshold σ can be determined according to the quantization parameter QP as: σ=[2̂(QP/0.6)−1]*0.8, similar to the calculation of parameter α and β in the deblocking filter in H.264/AVC in P. list, A. Joch, J. Lainema, G. Bjontegaard, and M. Karczewicz, “Adaptive deblocking filter”, in IEEE Trans. on Circuits and Systems for Video Technology (CSVT), 2003, the contents of which are incorporated by reference. Other QP dependent functions could also be used to calculate threshold σ.

At the encoder side, pixels Xₙ′ after mapping and pixel Xₙ without mapping will be used in Equation (18) to compute coefficients aₘ and bₙ simultaneously. Filtered frame will then be produced by applying filters as in Equation (17). The filter coefficients will be encoded and transmitted in the bitstream. At the decoder side, after the reconstructed frame is generated, ALF process is performed by first classifying the pixels or blocks based on directional features, and then applying the decoded filter coefficients aₘ and bₙ to pixel Xₙ without mapping and to pixels Xₙ′ after mapping, respectively.

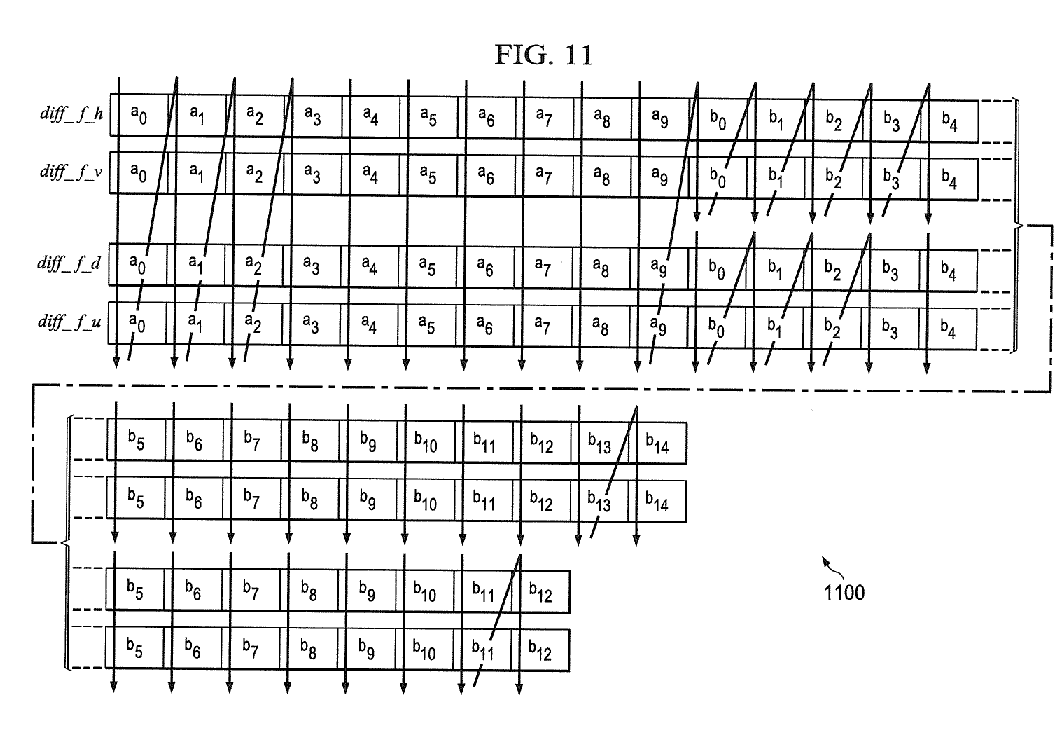

FIG. 11 illustrates a Scanning order for coefficient differences according to embodiments of the present disclosure. The embodiment of the scanning order 1100 shown in FIG. 11 is for illustration only. Other embodiments could be used without departing from the scope of this disclosure.

In certain embodiments, the ALF 110 is configured to employ efficient coding of filter coefficients. To further reduce the side information of transmitting filter coefficients, embodiments of the present disclosure provide two techniques for coding the coefficients prior to sending the coefficients to the “Entropy Coding” block 115 (in FIG. 1): a) Differential coding of filter coefficients between frames, and b) Scanning coefficients across filters within a frame.

In certain embodiments, the ALF 110 employs a differential coding of filter coefficients between frames. For the filter design, there will be four filters for a frame that utilizes adaptive loop filtering. The size of filter is fixed across different frames. The corresponding filters at different frames demonstrate similarity in their coefficients. Thus for frame m, instead of the ALF 110 sending the coefficients of f_hₘ, f_vₘ, f_dₘ, and f_uₘ directly to the entropy coding 115, differential coding is applied to only send the differences between filter coefficients of frame m and filter coefficients of previously encoded frame n, which also utilizes the adaptive loop filter 110. The differences are computed as follows:

diff_{—}f_{—}hₘ=f_{—}hₘ−f_{—}hₙ [Eqn. 21]

diff_{—}f_{—}vₘ=f_{—}vₘ−f_{—}vₙ [Eqn. 22]

diff_{—}f_{—}dₘ=f_{—}dₘ−f_{—}dₙ [Eqn. 23]

diff_{—}f_{—}uₘ=f_{—}uₘ−f_{—}uₙ [Eqn. 24]

In certain embodiments, to achieve the best differential coding results, the ALF 110 selects frame n as the temporally closest one to frame m, such that the two frames will have the most similar characteristics and thus higher similarity in their filters. Note that to frame m, this temporally closest frame n might not be the closest one in encoding order. For example, in hierarchical B coding structure with GOP size 8, the encoding order will be frames 0, 8, 4, 2, 6, 1, 3, 5, 7 . . . . For frame m=1, the closest one in encoder order is frame 6, while frame 0 or frame 2 are actually the temporally closest ones to frame 1. If all these frames use adaptive loop filtering, n should be selected as 0 or 2, instead of 6.

Another aspect with regards to the filter coefficients is that, across frames, coefficients aₖ from the spatial part tend to have smaller variations than coefficients bₖ from the directional filter part. After performing differential coding, differences in aₖ are typically smaller than differences in bₖ. If all the differences of one filter (such as a₁˜a₅ and b_{c}˜b₇ of diff_f_hm) are sent followed by all the differences of another filter (say diff_f_vm) to the entropy coder 415, it is likely the entropy coder 415 will see the differences increase within the first filter diff_f_hm, and then decrease when it get differences from another filter (such as b₇ of diff_f_hm followed by a₁ of diff_f_vm), and then increase again within the second filter diff_f_vm. This variation would lead to lower efficiency for context based entropy coder such as CABAC.

In certain embodiments, the ALF 110 is configured to use the scanning order 1100 for coefficient differences across filters within a frame. Differences of a0 of all filters will be scanned first followed by differences of a1. After all the aₖ coefficients, the ALF 110 will then scan differences bₖ for diff_f_hₘ and diff_f_vₘ, and finally scan differences bₖ for diff_f_dₘ and diff_f_uₘ. By doing so, the ALF 110 will send the differences to the entropy coder 115 with a gradually increasing order without sudden drops from large to small.

Note that the scanning order in 1100 can also be applied to filter coefficients themselves, not only to the filter coefficient differences. For example in 1100, each elements can be the coefficients from the filters f_hₘ, f_vₘ, f_dₘ, f_uₘ.

Besides classifying pixels or blocks into 4 directional classes as described above, in certain embodiments, the ALF 110 and 215 is configured to construct the filters by classifying pixels or blocks into two directional classes by computing and comparing for example two directional features in horizontal and vertical directions. Each directional class can optionally further be classified into more classes based on measurements of the strength of local variation.

Embodiments of the present disclosure provide examples of classification of 8 filters with two directional classes. To classify a 4×4 block B with pixels {X(i,j) |i=0, 1, 2, 3; j=0, 1, 2, 3}, the following 3 values are computed according to Equations 25 through 29 (reproduced here):

H_{B}=Σ_{i=0,2}Σ_{j=0,2}H(i,j) [Eqn. 25]

V_{B}=Σ_{i=0,2}Σ_{j=0,2}V(i,j) [Eqn. 26]

L_{B}=(H′_{B}+V′_{B})<<2 [Eqn. 27]

where

H(i,j)=abs(X(i,j)<<1−X(i,j−1)−X(i,j+1)) [Eqn. 28]

V(i,j)=abs(X(i,j)<<1−X(i−1,j)−X(i+1,j)) [Eqn. 29]

or

H(i,j)=abs(X(i,j)−X(i,j+1)) [Eqn. 30]

V(i,j)=abs(X(i,j)−X(i+1,j)) [Eqn. 31]

Note that the computation of above corresponds to feature computations at uniform sub-sampling of pixels as depicted by 610a through 610d. Other sub-sampling as described earlier in this disclosure can also be utilized. Then, for each directional class, there are four levels. The class label C_{B} of block B is obtained from the Table 2 “varTab_{—}8” below, as CB=varTab_{—}8 [dir][avgVar]:

TABLE 2
An example of varTab_8 for classify blocks into 8 classes

| | AvgVar | | | | | | | | | | | | | | | |
|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 |
| dir 0 | 0 | 1 | 1 | 2 | 2 | 2 | 2 | 3 | 3 | 3 | 3 | 3 | 3 | 3 | 3 | 3 |
| dir 1 | 4 | 5 | 5 | 6 | 6 | 6 | 6 | 7 | 7 | 7 | 7 | 7 | 7 | 7 | 7 | 7 |

dir=1, if V_{B}>H_{B}

dir=0, otherwise [Eqn. 32]

avgVar=max{15,(L_{B}*1024)>>(3+BitDepthY)} [Eqn. 33]

avgVar in Equation 33 is a normalized value of L_{B} from Equation 27, to measure the strength of variation in the block B. Other measurements using the sum of V_{B} and H_{B} can be used

Table 2 is just an example embodiment to utilize Equations 32 and 33. Other tables can also be constructed using similar principles with labels that cover larger avgVar range as they go from the left to right in the tables.

In Table 2, the labels run in the order of magnitude (avgVar) first followed by directional class (dir). In the case where the label-merging process follows a 1D pattern (that is, only labels with consecutive values can be merged together), Table 2 results in merging only for different magnitudes (avgVar) in the same directional class (dir), but not the other way around. Thus embodiments of the present disclosure present varTab_{—}8 in which the labels run in the order of directional class (dir) first followed by magnitude (avgVar), as below in Table 3.

TABLE 3
Another example of varTab_8 for classify blocks into 8 classes

| | avgVar | | | | | | | | | | | | | | | |
|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 |
| dir 0 | 0 | 2 | 2 | 4 | 4 | 4 | 4 | 6 | 6 | 6 | 6 | 6 | 6 | 6 | 6 | 6 |
| dir 1 | 1 | 3 | 3 | 5 | 5 | 5 | 5 | 7 | 7 | 7 | 7 | 7 | 7 | 7 | 7 | 7 |

Certain embodiments of the present disclosure provide classification of 8 filters with two directional classes and Scaled label table. In Table 2 and 3, for a given directional class (dir), there are more than half of the elements being assigned the same label (labels 3 and 7 in Table 2; labels 6 and 7 in Table 3). This indicates that a double of the value of avgVar (computed from LB) can be used, and the label distributions can be scaled accordingly to improve the classification in magnitude domain. In the following examples, the value L_{B} is scaled by two (doubled) and use modified tables varTab_{—}8S.

To classify a 4×4 block B with pixels {X(i,j)|i=0, 1, 2, 3; j=0, 1, 2, 3}, the following 3 values are computed:

H_{B}=Σ_{i=0,2}Σ_{j=0,2}H(i,j) [Eqn. 34]

V_{B}=Σ_{i=0,2}Σ_{j=0,2}H(i,j) [Eqn. 35]

L_{B}=(H_{B}+V_{B})<<1 [Eqn. 36]

where H(i,j)=abs(X(i,j)<<1−X(i,j−1)−X(i,j+1)), V(i,j)=abs(X(i,j)<<1−X(i−1,j)−X(i+1,j)); or

H(i,j)=abs(X(i,j)−X(i,j+1)), V(i,j)=abs(X(i,j)−X(i+1,j))

TABLE 4
An example of scaled varTab_8S for classify blocks into 8 classes

| | avgVar | | | | | | | | | | | | | | | |
|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 |
| dir 0 | 0 | 0 | 1 | 1 | 1 | 1 | 1 | 2 | 2 | 2 | 2 | 2 | 2 | 2 | 2 | 3 |
| dir 1 | 4 | 4 | 5 | 5 | 5 | 5 | 5 | 6 | 6 | 6 | 6 | 6 | 6 | 6 | 6 | 7 |

dir=1, if V_{B}>H_{B}

dir=0, otherwise

avgVar=max{15,(L_{B}*1024)>>(3+BitDepthY)}

In this example, while Equations 34 and 35 are the same as Equations 23 and 24, the computation of LB in Equation 25 is changed as shown in Equation 36 with only shift 1 bit, thus doubling its value. Label distribution in Table 4 is scaled to improve the classification of the doubled L_{B}.

Again, similar to the principle used in constructing Table 3, Table 4 is changed such that the labels run in a different order, as in Table 5 below.

TABLE 5
Another example of scaled varTab_8S for classify blocks into 8 classes

| | avgVar | | | | | | | | | | | | | | | |
|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 |
| dir 0 | 0 | 0 | 2 | 2 | 2 | 2 | 2 | 4 | 4 | 4 | 4 | 4 | 4 | 4 | 4 | 6 |
| dir 1 | 1 | 1 | 3 | 3 | 3 | 3 | 3 | 5 | 5 | 5 | 5 | 5 | 5 | 5 | 5 | 7 |

Table 4 and 5 are just example embodiments to utilize scaled value of L_{B}. Other scaling and the corresponding tables can also be constructed using similar principles:

1. The label distributions should follow accordingly to how the value L_{B} (hence avgVar) is scaled; and

2. Labels will cover larger avgVar range as they go from the left to right in the tables.

Embodiment example of classification using Hybrid label table:

It has been observed that for smaller avgVar index, directional classification using index dir might not provide best efficiency, due to the lack of directional features in the corresponding blocks with smaller L_{B} values. Thus, in certain embodiments, a hybrid label table is constructed, where the labels for smaller avgVar index are assigned across different direction index (dir). An example of such design varTab8S_HB, using scaled LB, is provided as follows. (Note that table can be constructed accordingly if scaling of L_{B} is not used.)

To classify a 4×4 block B with pixels {X(i,j) i=0, 1, 2, 3; j=0, 1, 2, 3}, the following three values are computed using Equations 34 through 36, reproduced here:

H_{B}=Σ_{i=0,2}Σ_{j=0,2}H(i,j) [Eqn. 34]

V_{B}=Σ_{i=0,2}Σ_{j=0,2}V(i,j) [Eqn. 35]

L_{B}=(H_{B}+V_{B})<<1 [Eqn. 36

where H(i,j)=abs(X(i,j)<<1−X(i,j−1)−X(i,j+1)), V(i,j)=abs (X(i,j)<<1−X(i−1,j)−X(i+1,j));

or H(i,j)=abs(X(i,j)−X(i,j+1)), V(i,j)=abs(X(i,j)−X(i+1,j))

TABLE 6
An example of varTab_8S_HB for classify a 4 × 4 block B into 8 classes

| | avgVar | | | | | | | | | | | | | | | |
|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 |
| dir 0 | 0 | 1 | 1 | 2 | 2 | 2 | 2 | 2 | 4 | 4 | 4 | 4 | 4 | 4 | 4 | 6 |
| dir 1 | 0 | 1 | 1 | 3 | 3 | 3 | 3 | 3 | 5 | 5 | 5 | 5 | 5 | 5 | 5 | 7 |

dir=1, if V_{B}>H_{B}

dir=0, otherwise

avgVar=max{15,(L_{B}*1024)>>(3+BitDepthY)}

Table 6 is just an example embodiment to constructed hybrid label table. Other tables (with or without scaling) can also be constructed using similar principles:

1. The labels for smaller avgVar index are assigned across different direction index (dir);

2. Labels will cover larger avgVar range as they go from the left to right in the tables; and optionally,

3. The label distributions should follow accordingly to how the value L_{B} (hence avgVar) is scaled.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus comprising:
a video/image encoder configured to design and apply multiple filters to video information, wherein the multiple filters are designed according to classification of the video information based on at least one local directional feature of the video information, and encode the filter coefficients of the multiple filters.

2. The encoder as set forth in claim 1, wherein the classification of the video information based on at least one local directional feature comprises computing and comparing the at least one local directional feature.

3. The encoder as set forth in claim 1, wherein the video information comprises a plurality of pixels, and wherein the encoder is configured to classify a pixel based on the at least one local directional feature of the pixel.

4. The encoder as set forth in claim 3, wherein the at least one local directional feature comprises a pixel-based feature computed as the summation of at least one difference between pixels along at least one direction to classify a pixel.

5. The encoder as set forth in claim 1, wherein video information comprises a plurality of blocks, each block comprising a plurality of pixels, and the encoder is configured to classify a block based on the at least one local directional feature of the block.

6. The encoder as set forth in claim 5, wherein the at least one local directional feature comprises a block-based feature computed as the summation of at least one difference between pixels along at least one directions to classify a block.

7. The encoder as set forth in claim 6, wherein the at least one difference between pixels along at least one direction is computed at subset of pixels within the block to be classified.

8. The encoder as set forth in claim 7, wherein the subset of pixels comprises pixels from uniform sub-sampling.

9. The encoder as set forth in claim 7, wherein the subset of pixels comprises pixels from quincunx sub-sampling.

10. The encoder as set forth in claim 7, wherein the subset of pixels comprises pixels from the center positions within the block to be classified.

11. The encoder as set forth in claim 7, wherein the subset of pixels comprises pixels from the top-left positions within the block to be classified.

12. The encoder as set forth in claim 1, wherein the at least one local directional feature comprises a feature computed as the summation of at least one difference between pixels along at least one of the horizontal, vertical, diagonal top-left to bottom-right, and diagonal bottom-left to top-right directions.

13. The encoder as set forth in claim 1, wherein the multiple filters comprises directional filters with symmetric constraints on the filter coefficients configured according to the classification of the video information based on at least one local directional feature of the video information.

14. The encoder as set forth in claim 13, wherein the symmetric constraints on the filter coefficients are configured according to the at least one direction the at least one direction comprising at least one of horizontal, vertical, diagonal top-left to bottom-right, and diagonal bottom-left to top-right directions.

15. The encoder as set forth in claim 1, wherein the video/image decoder configured to apply the multiple filters further by applying a non-liner hard-thresholding mapping to avoid using pixels with large difference to the pixel to be filtered.

16. The encoder as set forth in claim 1, wherein the encoder is configured to compute, encode, and transmit the filter coefficients differences between the filter coefficients of the current frame being encoded and the corresponding filter coefficients from a previously encoded frames.

17. The encoder as set forth in claim 16, wherein the encoder is configured to select the temporally closest frames as the previously encoded frames to compute, encode, and transmit the filter coefficients differences.

18. The encoder as set forth in claim 16, wherein the corresponding filter coefficients comprise filter coefficients in filters corresponding to the same directional class in the current frame being encoded and in the previously encoded frame.

19. The encoder as set forth in claim 1, wherein the encoder is configured to encode the filter coefficients in the order of scanning across one coefficient position of all filters followed by scanning across another coefficient position of all filters.

20. An apparatus comprising:
a video/image decoder configured to decode filter coefficients of multiple filters and apply the multiple filters to the video information, wherein the multiple filters are applied according to classification of the video information based on at least one local directional feature of the video information.

21. The decoder as set forth in claim 20, wherein the classification of the video information based on at least one local directional feature comprises computing and comparing the at least one local directional feature.

22. The decoder as set forth in claim 20, wherein video information comprises a plurality of pixels, and wherein the decoder is configured to classify a pixel based on the at least one local directional feature of the pixel

23. The decoder as set forth in claim 22, wherein the at least one local directional feature comprises a pixel-based feature computed as the summation of at least one difference between pixels along at least one direction to classify a pixel.

24. The decoder as set forth in claim 20, wherein video information comprises a plurality of blocks, each block comprising a plurality of pixels, and the decoder is configured to classify a block based on the at least one local directional feature of the block.

25. The decoder as set forth in claim 24, wherein the at least one local directional feature comprises a block-based feature computed as the summation of at least one difference between pixels along at least one directions to classify a block.

26. The decoder as set forth in claim 25, wherein the at least one difference between pixels along at least one direction is computed at subset of pixels within the block to be classified.

27. The decoder as set forth in claim 26, wherein the subset of pixels comprises pixels from uniform sub-sampling.

28. The decoder as set forth in claim 26, wherein the subset of pixels comprises pixels from quincunx sub-sampling.

29. The decoder as set forth in claim 26, wherein the subset of pixels comprises pixels from the center positions within the block to be classified.

30. The decoder as set forth in claim 26, wherein the subset of pixels comprises pixels from the top-left positions within the block to be classified.

31. The decoder as set forth in claim 20, wherein the at least one local directional feature comprises a feature computed as the summation of at least one difference between pixels along at least one of the horizontal, vertical, diagonal top-left to bottom-right, and diagonal bottom-left to top-right directions.

32. The decoder as set forth in claim 20, wherein the decoder is configured to construct from the decoded filter coefficients multiple filters with symmetric constraints on the filter coefficients configured according to the classification of the video information based on at least one local directional feature of the video information.

33. The decoder as set forth in claim 32, wherein the symmetric constraints on the filter coefficients are configured according to the at least one direction the at least one direction comprising at least one of horizontal, vertical, diagonal top-left to bottom-right, and diagonal bottom-left to top-right directions.

34. The decoder as set forth in claim 20, wherein the video/image decoder configured is configured to apply the multiple filters further by applying a non-liner hard-thresholding mapping to avoid using pixels with large difference to the pixel to be filtered.

35. The decoder as set forth in claim 20, wherein the decoder is configured to decode the filter coefficients of the current frame being decoded and add them to the corresponding filter coefficients from a previously decoded frame.

36. The decoder as set forth in claim 35, wherein the decoder is configured to select the temporally closest frames as the previously decoded frame to which the decoded current filter coefficients are added.

37. The decoder as set forth in claim 35, wherein the corresponding filter coefficients comprise filter coefficients in filters corresponding to the same directional class in the current frame being decoded and in the previously decoded frame.

38. The decoder as set forth in claim 20, wherein the decoder is configured to decode the filter coefficients in the order of scanning across one coefficient position of all filters followed by scanning across another coefficient position of all filters.

39. A method comprising:
designing multiple filters by classifying video information based on at least one local directional feature of the video information to design multiple filters;
encoding filter coefficients of the multiple filters; and
applying the multiple filters to the video information.

40. The method as set forth in claim 39, wherein classifying comprises computing and comparing the at least one local directional feature.

41. The method as set forth in claim 39, wherein the video information comprises a plurality of pixels, and classifying comprises classifying on a pixel basis based on the at least one local directional feature of the pixel.

42. The method as set forth in claim 41, wherein the at least one local directional feature comprises a pixel-based feature computed as the summation of at least one difference between pixels along at least one direction to classify a pixel.

43. The method as set forth in claim 39, wherein video information comprises a plurality of blocks, each block comprising a plurality of pixels, and classifying comprises classifying on a block based on the at least one local directional feature of the block.

44. The method as set forth in claim 43, wherein the at least one local directional feature comprises a block-based feature computed as the summation of at least one difference between pixels along at least one directions to classify a block.

45. The method as set forth in claim 44, further comprising computing the at least one difference between pixels along at least one direction at subset of pixels within the block to be classified.

46. The method as set forth in claim 45, wherein the subset of pixels comprises pixels from uniform sub-sampling.

47. The method as set forth in claim 45, wherein the subset of pixels comprises pixels from quincunx sub-sampling.

48. The method as set forth in claim 45, wherein the subset of pixels comprises pixels from the center positions within the block to be classified.

49. The method as set forth in claim 45, wherein the subset of pixels comprises pixels from the top-left positions within the block to be classified.

50. The method as set forth in claim 39, at least one local directional feature comprises a feature computed as the summation of at least one difference between pixels along at least one of the horizontal, vertical, diagonal top-left to bottom-right, and diagonal bottom-left to top-right directions.

51. The method as set forth in claim 39, further comprising configuring the multiple filters comprises directional filters with symmetric constraints on the filter coefficients according to the classification of the video information based on at least one local directional feature of the video information.

52. The method as set forth in claim 51, wherein the symmetric constraints on the filter coefficients are configured according to the at least one direction, the at least one direction comprising at least one of horizontal, vertical, diagonal top-left to bottom-right, and diagonal bottom-left to top-right directions.

53. The method as set forth in claim 39, applying the multiple filters comprises applying a non-liner hard-thresholding mapping to avoid using pixels with large difference to the pixel to be filtered.

54. The method as set forth in claim 39, further comprising computing, encoding, and transmitting the filter coefficients differences between the filter coefficients of the current frame being encoded and the corresponding filter coefficients from a previously encoded frames.

55. The method as set forth in claim 54, further comprising selecting the temporally closest frames as the previously encoded frames to compute, encode, and transmit the filter coefficients differences.

56. The method as set forth in claim 54, wherein the corresponding filter coefficients comprise filter coefficients in filters corresponding to the same directional class in the current frame being encoded and in the previously encoded frame.

57. The method as set forth in claim 39, further comprising encoding the filter coefficients in the order of scanning across one coefficient position of all filters followed by scanning across another coefficient position of all filters.

58. A method comprising:
decoding filter coefficients of multiple filters; and
applying the multiple filters to video information, wherein applying the multiple filters comprises classifying the video information based on at least one local directional feature of the video information.

59. The method as set forth in claim 58, wherein classifying the video information comprises classifying the video information based on at least one local directional feature comprises computing and comparing the at least one local directional feature.

60. The method as set forth in claim 58, wherein video information comprises a plurality of pixels, and wherein classifying the video information comprises classifying a pixel based on the at least one local directional feature of the pixel.

61. The method as set forth in claim 60, wherein the at least one local directional feature comprises a pixel-based feature computed as the summation of at least one difference between pixels along at least one direction to classify a pixel.

62. The method as set forth in claim 58, wherein video information comprises a plurality of blocks, each block comprising a plurality of pixels, and the encoder is configured to classify a block based on the at least one local directional feature of the block.

63. The method as set forth in claim 62, wherein the at least one local directional feature comprises a block-based feature computed as the summation of at least one difference between pixels along at least one directions to classify a block.

64. The method as set forth in claim 63, wherein the at least one difference between pixels along at least one direction is computed at subset of pixels within the block to be classified.

65. The method as set forth in claim 64, wherein the subset of pixels comprises pixels from uniform sub-sampling.

66. The method as set forth in claim 64, wherein the subset of pixels comprises pixels from quincunx sub-sampling.

67. The method as set forth in claim 64, wherein the subset of pixels comprises pixels from the center positions within the block to be classified.

68. The method as set forth in claim 64, wherein the subset of pixels comprises pixels from the top-left positions within the block to be classified.

69. The method as set forth in claim 58, wherein the at least one local directional feature comprises a feature computed as the summation of at least one difference between pixels along at least one of the horizontal, vertical, diagonal top-left to bottom-right, and diagonal bottom-left to top-right directions.

70. The method as set forth in claim 58, further comprising constructing, from the decoded filter coefficients, the multiple filters with symmetric constraints on the filter coefficients configured according to the classification of the video information based on at least one local directional feature of the video information.

71. The method as set forth in claim 70, wherein the symmetric constraints on the filter coefficients are configured according to the at least one direction, the at least one direction comprising at least one of horizontal, vertical, diagonal top-left to bottom-right, and diagonal bottom-left to top-right directions.

72. The method as set forth in claim 58, wherein applying the multiple filters comprises applying a non-liner hard-thresholding mapping to avoid using pixels with large difference to the pixel to be filtered.

73. The method as set forth in claim 58, further comprising decoding the filter coefficients of the current frame being decoded and add them to the corresponding filter coefficients from a previously decoded frame.

74. The method as set forth in claim 73, further comprising selecting the temporally closest frames as the previously decoded frame to which the decoded current filter coefficients are added.

75. The method as set forth in claim 73, wherein the corresponding filter coefficients comprise filter coefficients in filters corresponding to the same directional class in the current frame and in the previously decoded frame.

76. The method as set forth in claim 58, further comprising decoding the filter coefficients in the order of scanning across one coefficient position of all filters followed by scanning across another coefficient position of all filters.
